(19) United States
(12) Patent Application Publication
(10) Pub. No.: US 2024/0295400 A1
(43) Pub. Date: Sep. 5, 2024

(54) INFORMATION PROCESSING DEVICE, GUIDANCE SYSTEM, AND GUIDANCE METHOD

(71) Applicant: Mitsubishi Electric Corporation, Tokyo (JP)

(72) Inventor: Shinji MAEDA, Tokyo (JP)

(73) Assignee: Mitsubishi Electric Corporation, Tokyo (JP)

(21) Appl. No.: 18/659,617

(22) Filed: May 9, 2024

Related U.S. Application Data
(63) Continuation of application No. PCT/JP2022/001078, filed on Jan. 14, 2022.

(51) Int. Cl. G01C 21/20

(52) U.S. Cl. CPC G01C 21/206

(57) ABSTRACT

An information processing device includes an acquisition unit that acquires operation information as information indicating a present situation in a transportation system, a first present time, identification information, and facility information, an identification unit that identifies a congestion elimination time corresponding to the present situation by using the operation information, the first present time and the identification information and identifies a facility to which users should be guided based on the identified congestion elimination time and the facility information, a generation unit that generates information for guiding the users to the identified facility, and an output control unit that executes control for outputting the generated information.

### CROSS-REFERENCE TO RELATED APPLICATION

This application is a continuation application of International Application No. PCT/JP2022/001078 having an international filing date of Jan. 14, 2022.

### BACKGROUND OF THE INVENTION

### 1. Field of the Invention

The present disclosure relates to an information processing device, a guidance system, and a guidance method.

### 2. Description of the Related Art

A great number of users use stations (referred to also as transportation facilities, for example) of railroads, subways or the like. Congestion occurs in a station in the event of an accident or other incident. Therefore, a technology for eliminating the congestion has been proposed (see Patent Reference 1). A crowd flow guidance system in the Patent Reference 1 distributes guidance information for guiding people to a guidance destination holding area.
Patent Reference 1: Japanese Patent Application Publication No. 2015-108913

Guiding users to a facility as in the above-described technology increases the possibility of eliminating the congestion. However, when users are guided to a facility where the users' usage time is extremely short, the users will return to the station before the congestion is eliminated. If the users return to the station, the congestion is not eliminated. In contrast, when users are guided to a facility where the users' usage time is extremely long, the users cannot return to the station immediately after the congestion is eliminated. If a user returns to the station and then moves by using a transportation system, the time when the user arrives at the destination becomes considerably late.

Therefore, the guidance described above is undesirable.

### SUMMARY OF THE INVENTION

An object of the present disclosure is to guide users to an appropriate facility.

An information processing device according to an aspect of the present disclosure is provided. The information processing device includes an acquisition unit that acquires operation information as information indicating a present situation in a transportation system, a first present time, identification information as information for identifying a congestion elimination time in a transportation facility corresponding to the situation in the transportation system, and facility information as information indicating facilities existing in a vicinity of the transportation facility while also indicating a correspondence relationship between a total time based on a travel time and a staying time and a facility, an identification unit that identifies the congestion elimination time corresponding to the present situation by using the operation information, the first present time and the identification information and identifies a facility to which users should be guided based on the identified congestion elimination time and the facility information, a generation unit that generates information for guiding the users to the identified facility, and an output control unit that executes control for outputting the generated information.

According to the present disclosure, users can be guided to an appropriate facility.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing a guidance system in a first embodiment;

FIG. 2 is a diagram showing hardware included in an information processing device in the first embodiment;

FIG. 3 is a block diagram showing functions of the information processing device in the first embodiment;

FIG. 4 is a diagram showing an example of identification information in the first embodiment;

FIG. 5 is a diagram showing an example of facility information in the first embodiment;

FIG. 6 is a diagram showing an example of guidance facility information in the first embodiment;

FIGS. 7(A) and 7(B) are diagrams showing examples of an output state of a display device in the first embodiment;

FIG. 8 is a flowchart showing an example of a process executed by the information processing device in the first embodiment;

FIG. 9 is a diagram showing an example of user extension information in a modification of the first embodiment;

FIG. 10 is a diagram showing an example of an output state of a display device in the modification of the first embodiment; and

FIG. 11 is a block diagram showing functions of a display device in a second embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

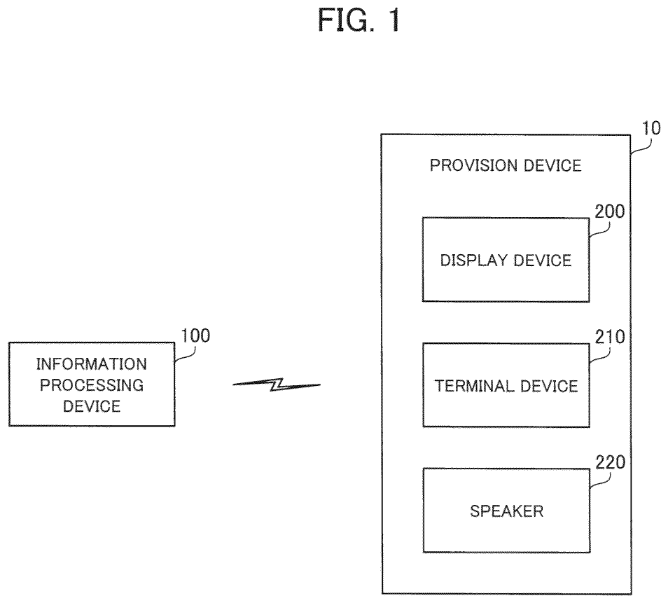

FIG. 1 is a diagram showing a guidance system in a first embodiment. The guidance system includes an information processing device 100 and a provision device 10. The information processing device 100 and the provision device 10 communicate with each other via a network. The network is a wired network or a wireless network.

The information processing device 100 is a device that executes a guidance method. The information processing device 100 is a server, for example.

The provision device 10 is a display device 200, a terminal device 210 or a speaker 220, for example. The display device 200 is a digital signage device, for example. The terminal device 210 is a smartphone, a tablet terminal or a Personal Computer (PC), for example. For example, the display device 200 and the speaker 220 are installed in a transportation facility. Incidentally, the transportation facility is a station, a bus terminal, or the like.

Next, hardware included in the information processing device 100 will be described below.

FIG. 2 is a diagram showing the hardware included in the information processing device in the first embodiment. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include a processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions of the information processing device 100 will be described below.

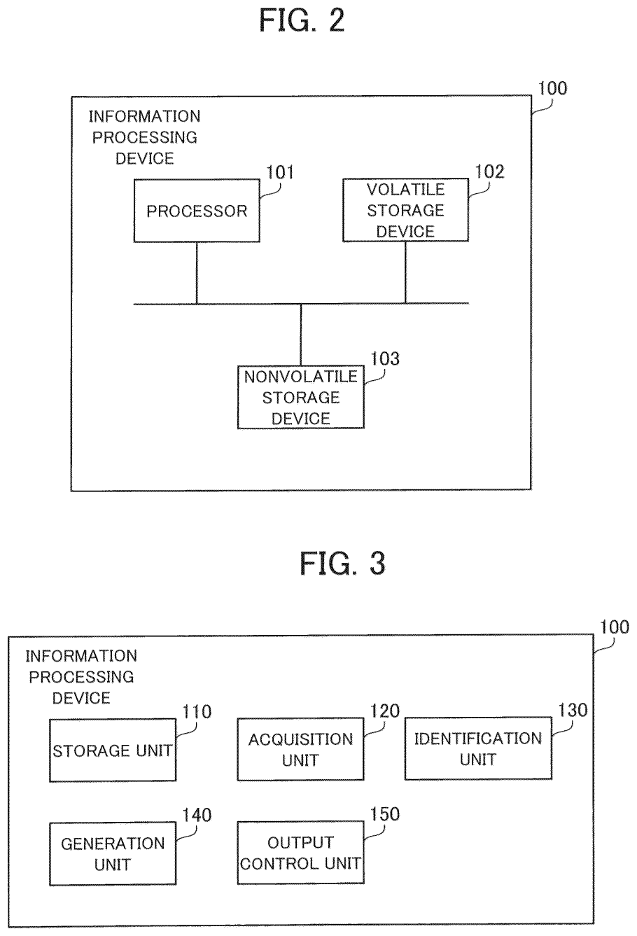

FIG. 3 is a block diagram showing the functions of the information processing device in the first embodiment. The information processing device 100 includes a storage unit 110, an acquisition unit 120, an identification unit 130, a generation unit 140 and an output control unit 150.

The storage unit 110 may be implemented as a storage area reserved in the volatile storage device 102 or the nonvolatile storage device 103.

Part or all of the acquisition unit 120, the identification unit 130, the generation unit 140 and the output control unit 150 may be implemented by a processing circuitry. Further, part or all of the acquisition unit 120, the identification unit 130, the generation unit 140 and the output control unit 150 may be implemented as modules of a program executed by the processor 101. For example, the program executed by the processor 101 is referred to also as a guidance program. The guidance program has been recorded in a record medium, for example.

The acquisition unit 120 acquires operation information. For example, the acquisition unit 120 acquires the operation information from an external device. The external device is a server installed in a station, for example.

The operation information is information indicating a present situation in a transportation system. The transportation system is a railroad, a subway, a monorail system, a bus system or the like, for example. For example, the operation information includes information indicating an accident, a delay, suspension of the service, or the like. For example, when the operation information includes information indicating an accident, the operation information further includes the name (e.g., Y station) of a station where the accident has occurred. Further, for example, when the operation information includes information indicating a delay, the operation information further includes a delay time. Furthermore, for example, when the operation information includes information indicating suspension of the service, the operation information further includes a suspension time and a suspension line/route.

Further, the acquisition unit 120 acquires a present time. For example, the acquisition unit 120 acquires the present time from a timer function of the information processing device 100. Incidentally, this present time is referred to also as a first present time.

Furthermore, the acquisition unit 120 acquires identification information. For example, the acquisition unit 120 acquires the identification information from the storage unit 110. Alternatively, for example, the acquisition unit 120 acquires the identification information from a storage device connectable to the information processing device 100. Incidentally, the identification information is information for identifying a congestion elimination time in a transportation facility corresponding to the situation in the transportation system. Here, an example of the identification information will be shown below.

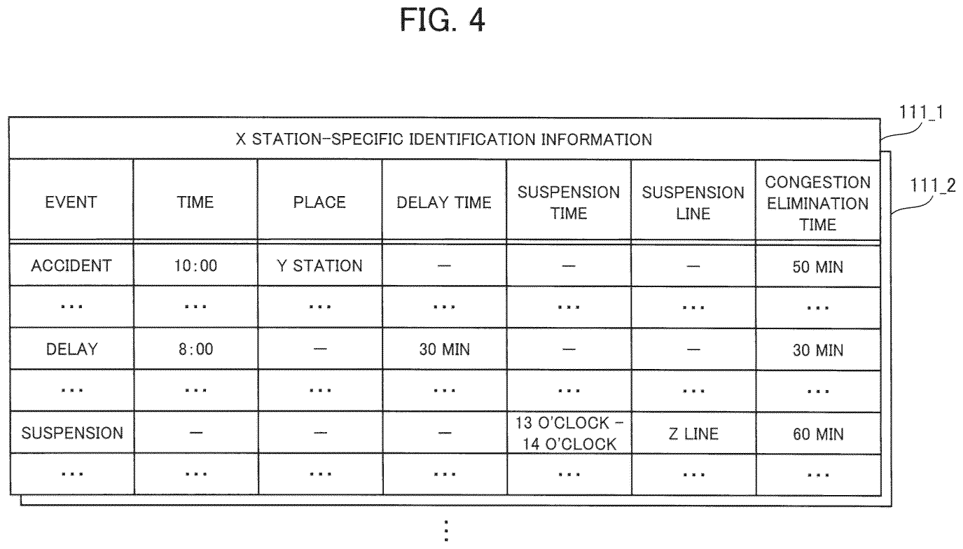

FIG. 4 is a diagram showing an example of the identification information in the first embodiment. For example, identification information 111_1, 111_2, etc. have been stored in the storage unit 110. The identification information 111_1, 111_2, etc. are generated based on past case examples.

For example, the identification information 111_1 is X station-specific identification information. When the information processing device 100 guides users to a facility existing in the vicinity of the X station, the acquisition unit 120 acquires the identification information 111_1.

The identification information 111_1, 111_2, etc. include the same items as each other. Thus, the items in the identification information 111_1 will be described below. Then, explanation of the items in the identification information 111_2, etc. will be left out. The identification information 111_1 includes items of event, time, place, delay time, suspension time, suspension line, and congestion elimination time.

For example, when an accident occurred in the past at the Y station at 10 o'clock, the time taken to eliminate congestion at the X station was 50 minutes. Therefore, this content has been registered in the identification information 111_1.

In the following description, the information processing device 100 is assumed to guide users to a facility existing in the vicinity of the X station. Thus, the acquisition unit 120 acquires the identification information 111_1.

Further, the acquisition unit 120 acquires facility information. For example, the acquisition unit 120 acquires the facility information from the storage unit 110. Alternatively, for example, the acquisition unit 120 acquires the facility information from a storage device connectable to the information processing device 100. Here, an example of the facility information will be shown below.

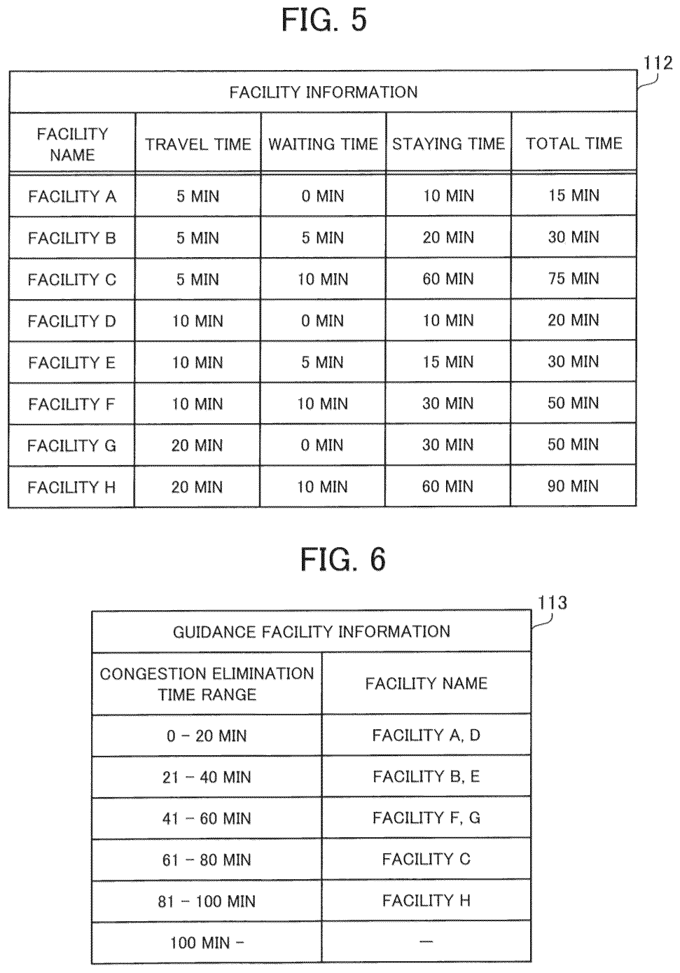

FIG. 5 is a diagram showing an example of the facility information in the first embodiment. For example, facility information 112 has been stored in the storage unit 110.

The facility information 112 is information indicating facilities existing in the vicinity of the X station while also indicating a correspondence relationship between a total time and a facility. Specifically, the facility information 112 includes items of facility name, travel time, waiting time, staying time, and total time. In the item of facility name, names of facilities existing in the vicinity of the X station are registered. In short, in the item of facility name, names of facilities as candidates for a guidance destination are registered. The travel time is a time taken to travel between the X station and the facility. In short, the travel time is a round-trip time. The waiting time is the time spent waiting at the facility. The staying time is the time spent staying at the facility. In the item of total time, the total value of the travel time, the waiting time and the staying time is registered. The total time may be regarded as a time corresponding to the congestion elimination time, or a usage time.

The identification unit 130 identifies the congestion elimination time by using the operation information, the present time and the identification information 111_1. For example, the operation information is assumed to include an event “accident” and a place “Y station”. The present time is assumed to be 10 o'clock. The identification unit 130 identifies the congestion elimination time “50 min” based on the identification information 111_1. The identified congestion elimination time can be regarded as a congestion elimination time corresponding to the present situation.

Further, when information coinciding with the present time and the operation information is not included in the identification information 111_1, the identification unit 130 may identify information similar to the present time and the operation information out of the identification information 111_1 and estimate the congestion elimination time based on the identified information. The identification unit 130 may identify the estimated congestion elimination time as the congestion elimination time corresponding to the present situation.

The identification unit 130 identifies a facility to which the users should be guided based on the congestion elimination time and the facility information 112. For example, when the congestion elimination time is 50 min, the identification unit 130 identifies the facility F and the facility G whose total time is “50 min” based on the facility information 112. Incidentally, the users may be represented also as users existing in the X station (i.e., transportation facility) or users using the transportation system.

Here, the generation unit 140 may generate guidance facility information based on the facility information 112. An example of the guidance facility information will be shown below.

FIG. 6 is a diagram showing an example of the guidance facility information in the first embodiment. The guidance facility information 113 indicates a correspondence relationship between a congestion elimination time range and a facility. Specifically, the guidance facility information 113 includes items of congestion elimination time range and facility name. The guidance facility information 113 is information generated by the generation unit 140. Specifically, the generation unit 140 generates the guidance facility information 113 based on the facility names and the total times in the facility information 112.

The identification unit 130 may identify the facility to which the users should be guided based on the identified congestion elimination time and the guidance facility information 113. For example, when the identified congestion elimination time is 40 min, the identification unit 130 identifies the facility B and the facility E based on the guidance facility information 113. Further, when information coinciding with the congestion elimination time identified by the identification unit 130 is not included in the facility information 112, the identification unit 130 may identify the facility to which the users should be guided based on the identified congestion elimination time and the guidance facility information 113.

When the number of the identified facilities is less than or equal to a predetermined threshold value, the identification unit 130 may execute an addition process of adding a predetermined value to the identified congestion elimination time or a subtraction process of subtracting a predetermined value from the identified congestion elimination time. Incidentally, the predetermined value is desired to be a small value. The identification unit 130 may further identify a facility to which the users should be guided based on a value obtained by executing the addition process or the subtraction process and the facility information 112 or the guidance facility information 113.

For example, the threshold value is assumed to be “1”. The predetermined value is assumed to be “15”. When the congestion elimination time is 75 min, the identification unit 130 identifies the facility C whose total time is “75 min” based on the facility information 112. The identification unit 130 judges that the number of the identified facilities is less than or equal to the threshold value. The identification unit 130 adds “15” to “75”. The identification unit 130 further identifies the facility H whose total time is “90 min” based on a value “90” obtained by executing the addition and the facility information 112. Accordingly, the identification unit 130 identifies the facility C and the facility H as the facilities to which the users should be guided.

Further, for example, the threshold value is assumed to be “1”. The predetermined value is assumed to be “15”. When the congestion elimination time is 75 min, the identification unit 130 identifies the facility C based on the guidance facility information 113. The identification unit 130 judges that the number of the identified facilities is less than or equal to the threshold value. The identification unit 130 subtracts “15” from “75”. The identification unit 130 further identifies the facility F and the facility G based on a value “60” obtained by executing the subtraction and the guidance facility information 113. Accordingly, the identification unit 130 identifies the facility C, the facility F and the facility G as the facilities to which the users should be guided.

Here, when the number of the identified facilities is less than or equal to the threshold value, the users rush to the identified facilities. For example, when the threshold value is “1”, the users are guided to one facility, and thus the users rush to the one facility. Therefore, the information processing device 100 disperses the guidance of the users by further identifying a facility. Accordingly, the information processing device 100 is capable of mitigating the rush of the users.

The generation unit 140 generates information for guiding the users to the identified facility or facilities.

The output control unit 150 executes control for outputting the generated information. For example, when the provision device 10 is the display device 200, the output control unit 150 executes control for making the display device 200 output the information. Specifically, the output control unit 150 transmits the information and a command for outputting the information to the display device 200. Accordingly, the display device 200 outputs the information.

Further, for example, when the provision device 10 is the terminal device 210, the output control unit 150 executes control for making the terminal device 210 output the information. Specifically, the output control unit 150 transmits the information and a command for outputting the information to the terminal device 210. Accordingly, the terminal device 210 outputs the information.

Furthermore, for example, when the provision device 10 is the speaker 220, the output control unit 150 executes control for making the speaker 220 output the generated information (i.e., audio information). Specifically, the output control unit 150 transmits the audio information and a command for outputting the audio information to the speaker 220. Accordingly, the speaker 220 outputs audio.

Here, examples of a state in which the display device 200 is outputting the generated information will be shown below.

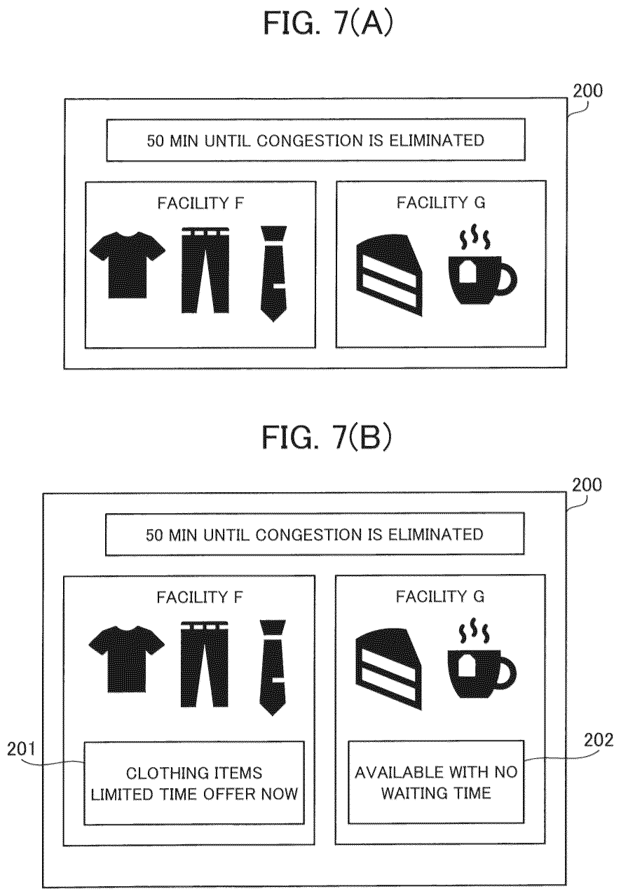

FIGS. 7(A) and 7(B) are diagrams showing examples of an output state of the display device in the first embodiment. FIG. 7(A) shows a state in which the display device 200 is outputting the generated information.

Here, the acquisition unit 120 may acquire advertisement information regarding the facility or facilities identified by the identification unit 130. For example, the acquisition unit 120 acquires the advertisement information from the storage unit 110. Alternatively, for example, the acquisition unit 120 acquires the advertisement information from a storage device connectable to the information processing device 100.

When the advertisement information has been acquired, the generation unit 140 generates information for guiding the users to the identified facility or facilities that includes the advertisement information.

FIG. 7(B) shows a state in which information including advertisement information 201 and 202 is outputted. With the advertisement information 201 and 202 outputted as above, the users positively feel like going to the facilities. Thus, the information processing device 100 is capable of promoting the guidance of the users by generating the information including the advertisement information 201 and 202.

Next, a process executed by the information processing device 100 will be described below by using a flowchart.

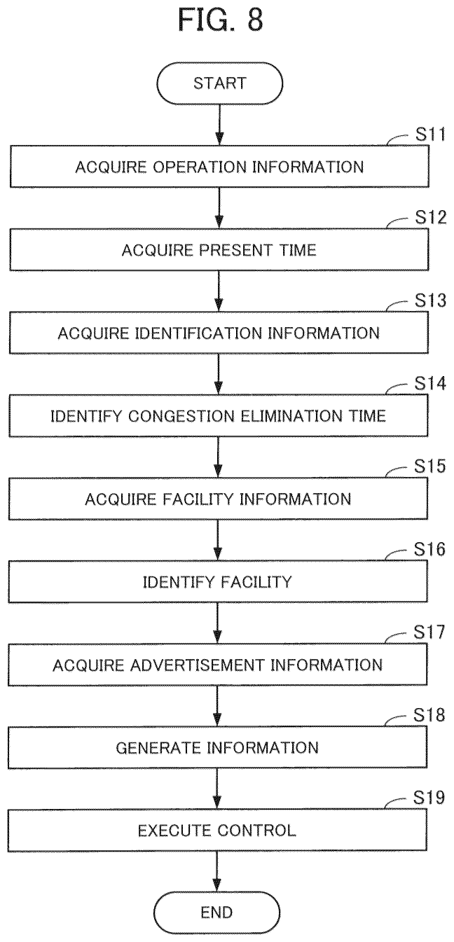

FIG. 8 is a flowchart showing an example of the process executed by the information processing device in the first embodiment.
(Step S11) The acquisition unit 120 acquires the operation information.
(Step S12) The acquisition unit 120 acquires the present time.
(Step S13) The acquisition unit 120 acquires the identification information 111_1.
(Step S14) The identification unit 130 identifies the congestion elimination time by using the operation information, the present time and the identification information 111_1.
(Step S15) The acquisition unit 120 acquires the facility information 112.
(Step S16) The identification unit 130 identifies the facility to which the users should be guided based on the congestion elimination time and the facility information 112. The identification unit 130 is assumed to identify the facility F and the facility G.
(Step S17) The acquisition unit 120 acquires the advertisement information 201 regarding the facility F and the advertisement information 202 regarding the facility G.
(Step S18) The generation unit 140 generates information for guiding the users to the facilities F and G that includes the advertisement information 201 and 202.
(Step S19) The output control unit 150 executes the control for making the display device 200 output the information.

Accordingly, the display device 200 outputs information like that shown in FIG. 7(B), for example.

According to the first embodiment, the information processing device 100 identifies the congestion elimination time by using the identification information 111_1, identifies a facility corresponding to the identified congestion elimination time, generates the information for guiding the users to the identified facility, and executes the control for outputting the information. Accordingly, the information processing device 100 is capable of preventing the users from being guided to a facility where the usage time is extremely short. The information processing device 100 is also capable of preventing the users from being guided to a facility where the usage time is extremely long. Therefore, the information processing device 100 is capable of guiding the users to an appropriate facility.

Further, the facility information 112 includes the waiting time. The facility information 112 does not necessarily have to include the waiting time. However, with the facility information 112 including the waiting time, the information processing device 100 is capable of identifying a more appropriate facility by using a more accurate total time (i.e., more accurate time corresponding to the congestion elimination time).

The output control unit 150 may output newest information in adaptation with the congestion elimination time. The process will be described in detail below. The acquisition unit 120 acquires a second present time as a time after the information generated by the generation unit 140 is outputted. The identification unit 130 calculates a newest congestion elimination time based on the identified congestion elimination time, the first present time and the second present time. The calculation process will be described below by using a concrete example. For example, the identified congestion elimination time is the congestion elimination time “50 min” identified in the step S14. The first present time is the present time “10:00” acquired in the step S12. The second present time as a time after the step S19 is “10:20”. The identification unit 130 calculates the difference between the first present time “10:00” and the second present time “10:20”. By this calculation, “20 min” is obtained. The identification unit 130 calculates the newest congestion elimination time “30 min” based on the congestion elimination time “50 min” and the difference “20 min”. The identification unit 130 identifies the facilities B and E to which the users should be guided based on the newest congestion elimination time “30 min” and the facility information 112. The generation unit 140 generates the information for guiding the users to the facilities B and E. The output control unit 150 executes the control for outputting the generated information.

Here, for example, when the congestion elimination time is “50 min”, guiding the users to the facilities F and G is desirable. However, continuously guiding the users to the facilities F and G in spite of the elapse of a time is undesirable. Therefore, when time has elapsed (i.e., when the congestion elimination time has changed from “50 min” to “30 min”), the information processing device 100 guides the users to the facilities B and E corresponding to the newest congestion elimination time “30 min”. Accordingly, the information processing device 100 is capable of guiding the users to appropriate facilities.

Further, when identifying the facilities, the identification unit 130 may also use the guidance facility information 113. Specifically, the identification unit 130 identifies the facilities to which the users should be guided based on the newest congestion elimination time and the guidance facility information 113.

### Modification of First Embodiment

Next, a modification of the first embodiment will be described below.

The acquisition unit 120 further acquires user extension information. For example, the acquisition unit 120 acquires the user extension information from the storage unit 110. For example, the acquisition unit 120 acquires the user extension information from a storage device connectable to the information processing device 100. Here, an example of the user extension information will be shown below.

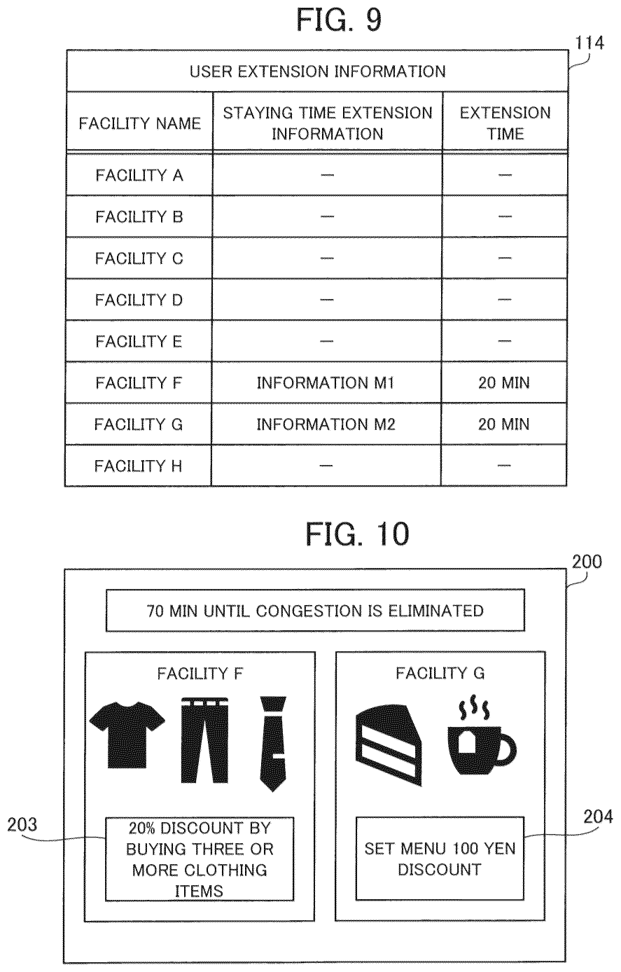

FIG. 9 is a diagram showing an example of the user extension information in the modification of the first embodiment. The user extension information 114 indicates a correspondence relationship among each facility, staying time extension information and a time. Specifically, the user extension information 114 includes items of facility name, staying time extension information and extension time.

In the item of facility name, the name of each facility is registered. In the item of staying time extension information, information for extending the staying time of the users is registered. In the item of extension time, a time is registered.

For example, a facility name “facility F”, staying time extension information “information M1”, and an extension time “20 min” have been registered in the user extension information 114. For example, the “information M1” is assumed to be “20% discount by buying three or more clothing items”. Here, when a user buys three or more clothing items, the user needs a time of “20 min”. Therefore, the extension time “20 min” has been associated with the “information M1”.

The identification unit 130 identifies the congestion elimination time by using the operation information, the present time and the identification information 111_1. For example, the identified congestion elimination time is assumed to be “70 min”. The identification unit 130 identifies the facility to which the users should be guided based on the identified congestion elimination time, the facility information 112 and the user extension information 114. Specifically, the identification unit 130 calculates 50 (=70−20) min based on the extension time “20 min” in the user extension information 114 and the congestion elimination time “70 min”. The identification unit 130 identifies the facility F and the facility G based on the facility information 112. As above, since the users stay at the facility to which they are guided for 20 min, the identification unit 130 identifies the facilities F and G corresponding to the total time “50 min”. Alternatively, specifically, the identification unit 130 adds the extension time in the user extension information 114 to the total time in the facility information 112. By this addition, the total time corresponding to the facilities F and G turns into “70 min”. The identification unit 130 identifies the facilities F and G corresponding to the total time “70 min” based on the congestion elimination time “70 min”.

Alternatively, the identification unit 130 identifies the facility to which the users should be guided based on the identified congestion elimination time, the guidance facility information 113 and the user extension information 114. For example, when 50 (=70−20) min has been calculated, the identification unit 130 identifies the facility F and the facility G based on the guidance facility information 113.

The generation unit 140 generates information for guiding the users to the facilities F and G that includes the staying time extension information corresponding to the facilities F and G.

The output control unit 150 executes the control for outputting the information. For example, the output control unit 150 executes the control for making the display device 200 output the information. An example of a state in which the information is outputted to the display device 200 will be shown below.

FIG. 10 is a diagram showing an example of the output state of the display device in the modification of the first embodiment. The display device 200 outputs information including information 203 and information 204. For example, the information 203 is the “information M1”. The information 204 is “information M2”.

According to the modification of the first embodiment, the information processing device 100 is capable of guiding users to an appropriate facility in consideration of the extension time.

### Second Embodiment

Next, a second embodiment will be described below. In the second embodiment, the description will be given mainly of features different from those in the first embodiment or the modification of the first embodiment. In the second embodiment, the description is omitted for features in common with the first embodiment or the modification of the first embodiment.

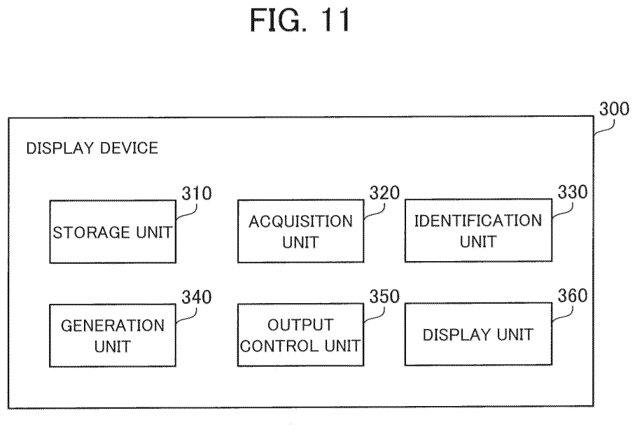

FIG. 11 is a block diagram showing functions of a display device in the second embodiment. The display device 300 may be referred to also as an information processing device. The display device 300 is a digital signage, for example.

The display device 300 includes a storage unit 310, an acquisition unit 320, an identification unit 330, a generation unit 340, an output control unit 350 and a display unit 360.

The storage unit 310 may be implemented as a storage area reserved in a volatile storage device or a nonvolatile storage device included in the display device 300.

Part or all of the acquisition unit 320, the identification unit 330, the generation unit 340, the output control unit 350 and the display unit 360 may be implemented by a processing circuitry included in the display device 300. Further, part or all of the acquisition unit 320, the identification unit 330, the generation unit 340, the output control unit 350 and the display unit 360 may be implemented as modules of a program executed by a processor included in the display device 300.

The storage unit 310 may store the same information as the storage unit 110.

Functions of the acquisition unit 320, the identification unit 330 and the generation unit 340 are the same as those of the acquisition unit 120, the identification unit 130 and the generation unit 140. Therefore, a description of the functions of the acquisition unit 320, the identification unit 330 and the generation unit 340 is left out.

The output control unit 350 executes control for making the display unit 360 output information generated by the generation unit 340. Specifically, the output control unit 350 transmits the information and a command for outputting the information to the display unit 360. When receiving the information and the command for outputting the information, the display unit 360 displays the information.

According to the second embodiment, the display device 300 is capable of guiding the users to an appropriate facility similarly to the first embodiment.

Features in the embodiments described above can be appropriately combined with each other.

### DESCRIPTION OF REFERENCE CHARACTERS

10: provision device, 100: information processing device, 101: processor, 102: volatile storage device, 103: nonvolatile storage device, 110: storage unit, 111_1, 111_2: identification information, 112: facility information 112, 113: guidance facility information, 114: user extension information, 120: acquisition unit, 130: identification unit, 140: generation unit, 150: output control unit, 200: display device, 201: advertisement information, 202: advertisement information, 203: information, 204: information, 210: terminal device, 220: speaker, 300: display device, 310: storage unit, 320: acquisition unit, 330: identification unit, 340: generation unit, 350: output control unit, 360: display unit

What is claimed is:

1. An information processing device comprising:
acquiring circuitry to acquire operation information as information indicating a present situation in a transportation system, a first present time, identification information, and facility information, the identification information being information for identifying a congestion elimination time in a transportation facility corresponding to the situation in the transportation system, the facility information being information indicating facilities existing in a vicinity of the transportation facility while also indicating a correspondence relationship between a facility and a total time based on a travel time and a staying time;
identifying circuitry to identify the congestion elimination time corresponding to the present situation by using the operation information, the first present time and the identification information and identify a facility to which users should be guided based on the identified congestion elimination time and the facility information;
generating circuitry to generate information for guiding the users to the identified facility; and
output controlling circuitry to execute control for outputting the generated information.

2. The information processing device according to claim 1, wherein the total time includes a waiting time.

3. The information processing device according to claim 1, wherein
the acquiring circuitry acquires user extension information indicating a correspondence relationship among each facility, staying time extension information as information for extending the staying time of the users, and a time,
the identifying circuitry identifies the facility to which the users should be guided based on the identified congestion elimination time, the facility information and the user extension information, and
the generating circuitry generates the information for guiding the users to the identified facility that includes the staying time extension information corresponding to the identified facility.

4. The information processing device according to claim 1, wherein
the acquiring circuitry acquires a second present time as a time after the generated information is outputted,
the identifying circuitry calculates a newest congestion elimination time based on the identified congestion elimination time, the first present time and the second present time and identifies a facility to which the users should be guided based on the newest congestion elimination time and the facility information,
the generating circuitry generates the information for guiding the users to the identified facility, and
the output controlling circuitry executes the control for outputting the generated information.

5. The information processing device according to claim 1, wherein
the generating circuitry generates guidance facility information, indicating a correspondence relationship between a facility and a congestion elimination time range based on the total time, based on the facility information, and
the identifying circuitry identifies the facility to which the users should be guided based on the identified congestion elimination time and the guidance facility information.

6. The information processing device according to claim 5, wherein
the acquiring circuitry acquires user extension information indicating a correspondence relationship among each facility, staying time extension information as information for extending the staying time of the users, and a time,
the identifying circuitry identifies the facility to which the users should be guided based on the identified congestion elimination time, the guidance facility information and the user extension information, and
the generating circuitry generates the information for guiding the users to the identified facility that includes the staying time extension information corresponding to the identified facility.

7. The information processing device according to claim 5, wherein
the acquiring circuitry acquires a second present time as a time after the generated information is outputted,
the identifying circuitry calculates a newest congestion elimination time based on the identified congestion elimination time, the first present time and the second present time and identifies a facility to which the users should be guided based on the newest congestion elimination time and the guidance facility information,
the generating circuitry generates the information for guiding the users to the identified facility, and
the output controlling circuitry executes the control for outputting the generated information.

8. The information processing device according to claim 5, wherein
when a number of identified facilities is less than or equal to a predetermined threshold value, the identifying circuitry executes an addition process of adding a predetermined value to the identified congestion elimination time or a subtraction process of subtracting a predetermined value from the identified congestion elimination time, and
further identifies a facility to which the users should be guided based on a value obtained by executing the addition process or the subtraction process and the facility information or the guidance facility information.

9. The information processing device according to claim 1, wherein
the acquiring circuitry acquires advertisement information regarding the identified facility, and
the generating circuitry generates the information for guiding the users to the identified facility that includes the advertisement information.

10. The information processing device according to claim 1, wherein
the output controlling circuitry executes control for making a provision device output the generated information, and
the provision device is a display device, a terminal device or a speaker.

11. The information processing device according to claim 1, further comprising displaying circuitry, wherein
the output controlling circuitry executes control for making the displaying circuitry output the generated information, and
the displaying circuitry displays the generated information.

12. A guidance system comprising:
a provision device; and
an information processing device, wherein
the information processing device includes:
acquiring circuitry to acquire operation information as information indicating a present situation in a transportation system, a first present time, identification information, and facility information, the identification information being information for identifying a congestion elimination time in a transportation facility corresponding to the situation in the transportation system, the facility information being information indicating facilities existing in a vicinity of the transportation facility while also indicating a correspondence relationship between a facility and a total time based on a travel time and a staying time;
identifying circuitry to identify the congestion elimination time corresponding to the present situation by using the operation information, the first present time and the identification information and identify a facility to which users should be guided based on the identified congestion elimination time and the facility information;
generating circuitry to generate information for guiding the users to the identified facility; and
output controlling circuitry to execute control for outputting the generated information.

13. A guidance method performed by an information processing device, the guidance method comprising:
acquiring operation information as information indicating a present situation in a transportation system, a first present time, identification information, and facility information, the identification information being information for identifying a congestion elimination time in a transportation facility corresponding to the situation in the transportation system, the facility information being information indicating facilities existing in a vicinity of the transportation facility while also indicating a correspondence relationship between a facility and a total time based on a travel time and a staying time;
identifying the congestion elimination time corresponding to the present situation by using the operation information, the first present time and the identification information;
identifying a facility to which users should be guided based on the identified congestion elimination time and the facility information;
generating information for guiding the users to the identified facility; and
executing control for outputting the generated information.

14. An information processing device comprising:
a processor to execute a program; and
a memory to store the program which, when executed by the processor, performs processes of,
acquiring operation information as information indicating a present situation in a transportation system, a first present time, identification information, and facility information, the identification information being information for identifying a congestion elimination time in a transportation facility corresponding to the situation in the transportation system, the facility information being information indicating facilities existing in a vicinity of the transportation facility while also indicating a correspondence relationship between a facility and a total time based on a travel time and a staying time,
identifying the congestion elimination time corresponding to the present situation by using the operation information, the first present time and the identification information,
identifying a facility to which users should be guided based on the identified congestion elimination time and the facility information,
generating information for guiding the users to the identified facility, and
executing control for outputting the generated information.
